(19) United States
(12) Patent Application Publication
(10) Pub. No.: US 2022/0227553 A1
(43) Pub. Date: Jul. 21, 2022

(54) PACKAGING ROLL FILM AND PREPARATION METHOD THEREOF

(71) Applicant: Zhejiang Yajia Cotton Picker Parts Co., Ltd., Zhuji City (CN)

(72) Inventor: Wuchuan ZHU, Zhuji City (CN)

(73) Assignee: Zhejiang Yajia Cotton Picker Parts Co., Ltd.

(21) Appl. No.: 17/207,927

(22) Filed: Mar. 22, 2021

(30) Foreign Application Priority Data
Jan. 18, 2021 (CN) 202110061522.2

(51) Int. Cl. B65D 65/14; B65H 18/28

(52) U.S. Cl. CPC B65D 65/14; A01F 2015/0745; B65H 18/28

(57) ABSTRACT

Packaging roll films and preparation methods thereof are provided. A first transparent adhesive tape layer may be capable of covering a second high-adhesion layer such that the problem caused by the exposed second high-adhesion layer may be solved. The adhesive film and the non-adhesive film may not need to completely cover the second high-adhesion layer during the process. When the roll film is unrolled for packaging an item, the rolling drum may stop rotating at the end of a cycle of the previous packaging section; the item may continue to rotate due to inertia and thereby generate a tension force at the position where a previous packaging section and a latter packaging section are connected. A parting layer may be parted from the second high-adhesion layer, allowing the non-adhesive film on the latter packaging section to be unrolled, and enabling the adhesive film of the previous section to continue wrapping.

This application claims priority to, and incorporates herein in its entirety, Chinese Patent Application No. 202110061522.2, filed Jan. 18, 2021.

### TECHNICAL FIELD

This disclosure generally relates to the technical field of packaging materials, and more particularly, to a packaging roll film and a preparation method thereof.

### BACKGROUND

In traditional packaging operations, a roll film wound around a rolling drum is normally utilized to package items (e.g., round, square or other shaped). The end of the roll film section is bonded to a roll film layer underneath the roll film, thereby maintaining a firm wrapping of each item. For example, during the operation of a cotton picker, cotton may be wrapped and packaged via roll film. Each packaging section of the roll film wound on the rolling drum typically includes a non-adhesive roll film section and an adhesive roll film section. During packaging, the cotton is first wrapped by the non-adhesive roll film section for multiple turns, and then wrapped by the adhesive roll film section for multiple turns. The portions of the wound roll film in contact with each other during the wrapping of the adhesive roll film area are adhered but detachable, thus enabling the tail end of the adhesive roll film section to be bonded to the adhesive roll film section located underneath. During the wrapping process, the item(s) being wrapped is typically rotated.

Chinese Patent Application No. 20038010024.X, titled “Packaging Material Having a Z-shaped Locking System and Method for Preparing and Using the Same” discloses a packaging material comprising a first packaging portion, a second packaging portion, and at least one Z-shaped locking portion. The ends of the first packaging portion and the second packaging portion are bonded through the Z-shaped locking portion in order to allow the first and second packaging portions to be joined and separated in a packaging cycle.

To prepare this packaging material, a first high-adhesion layer, a base layer, a parting layer, and a second high-adhesion layer are sequentially arranged on the second packaging portion. Subsequently, the ends of the first packaging portion are bonded to the second high-adhesion layer, thus enabling the edge of the second high-adhesion layer to be aligned with the edge of the first packaging portion. However, at this point, if the second high-adhesion layer is not completely covered by the first packaging portion, the second high-adhesion layer that is exposed in the rolling process of the packaging material may be bonded to the rest of the packaging material. Moreover, when the first packaging portion and the second packaging portion are separated in the packaging process, if the edge of the first packaging portion protrudes from the second high-adhesion layer, the protruding portion may be easily bonded to the second high-adhesion layer, resulting in a poor bonding effect of the second high-adhesion layer.

### SUMMARY

The present disclosure provides a description packaging roll film, components and aspect thereof, and methods of use and manufacture thereof to address the perceived problems described above. More specifically, the present disclosure provides an improved packaging roll film and a convenient method of preparing thereof.

In one embodiment, a packaging roll film is provided. The packaging roll film may include a plurality of packaging sections connected end to end. Each packaging section may include a non-adhesive film and an adhesive film that is connected to the non-adhesive film. A bonding structure may be disposed where the adhesive film and the non-adhesive film of second and first adjacent packaging sections, respectively, are connected. The bonding structure may include a first high-adhesion layer arranged on the non-adhesive film, a base layer bonded to a surface of the first high-adhesion layer, a parting layer arranged on an upper surface of the base layer, and a second high-adhesion layer bonded to the parting layer. The second high-adhesion layer may be capable of being separated from the parting layer. An end portion of the non-adhesive film may be bonded to an upper surface of the second high-adhesion layer. A first end portion of the adhesive film may be bonded to the upper surface of the second high-adhesion layer. A second end portion surface of the adhesive film away from the second high-adhesion layer may be bonded to the end portion surface of the non-adhesive film using a first transparent adhesive tape. A tearing line may be disposed between a second portion of the non-adhesive film provided with the base layer and the end portion of the non-adhesive film which is bonded to the second high-adhesion layer. The non-adhesive film may be bent in a Z-shape such that a third portion of the non-adhesive film extends in a direction away from the adhesive film.

The first end portion of the adhesive film bonded to the second high-adhesion layer and the end portion of the non-adhesive film bonded to the second high-adhesion layer may be in direct contact.

The first end portion of the adhesive film bonded to the second high-adhesion layer and the end portion of the non-adhesive film bonded to the second high-adhesion layer may be separated.

The end portion of the non-adhesive film, the second portion of the non-adhesive film, and a portion of the non-adhesive film therebetween may form an extension portion. The length of the extension portion may be 10-20 centimeters. The tearing line may be disposed in the middle of the extension portion. The length of the extension portion may be 12 centimeters.

The non-adhesive film and the adhesive film in the same packaging section may be bonded using a second transparent adhesive tape.

In another embodiment, a method for preparing a packaging roll film is provided. The method may include steps of preparing packaging sections and connecting adjacent packaging sections.

The step of preparing packaging sections may include bonding a non-adhesive film and an adhesive film using a second transparent adhesive tape to form each packaging section, and processing a tearing line on the non-adhesive film on a first end of the non-adhesive film away from the bonded adhesive film.

The step of connecting two adjacent packaging sections may include coating a portion of the first end of the non-adhesive film of a first packaging section of the adjacent packaging sections with an adhesion agent to form a first high-adhesion layer, bonding a base material on the first high-adhesion layer to form a base layer, coating a parting agent on the base layer to form a parting layer, coating an adhesion agent on the parting layer to form a second high-adhesion layer, bending the first end of the non-adhesive film and bonding a bent portion of the first end to the second high-adhesion layer, bonding an end of the adhesive film of a second packaging section of the adjacent packaging sections to the second high-adhesion layer, bonding the adhesive film of the second packaging section to the non-adhesive film using a first transparent adhesive tape, and bending a second end of the non-adhesive film of the first packaging section away from the second packaging section.

The method for preparing a packaging roll film may further include repeating the step of connecting two adjacent packaging sections to form a packaging film of at least three packaging sections connected end to end. The method may further include a step of rolling up the at least three packaging sections to form a roll.

### BRIEF DESCRIPTION OF THE DRAWINGS

The accompanying drawings, which are incorporated into and constitute a part of this disclosure, illustrate several embodiments and aspects of the compositions, and methods described herein and, together with the description, serve to explain the principles of the invention.

FIG. 1 is a conceptual diagram illustrating an exemplary structure of the packaging roll film, in accordance with a first embodiment.

FIG. 2 is a conceptual diagram illustrating an exemplary structure of the packaging roll film, in accordance with a second embodiment.

### DETAILED DESCRIPTION

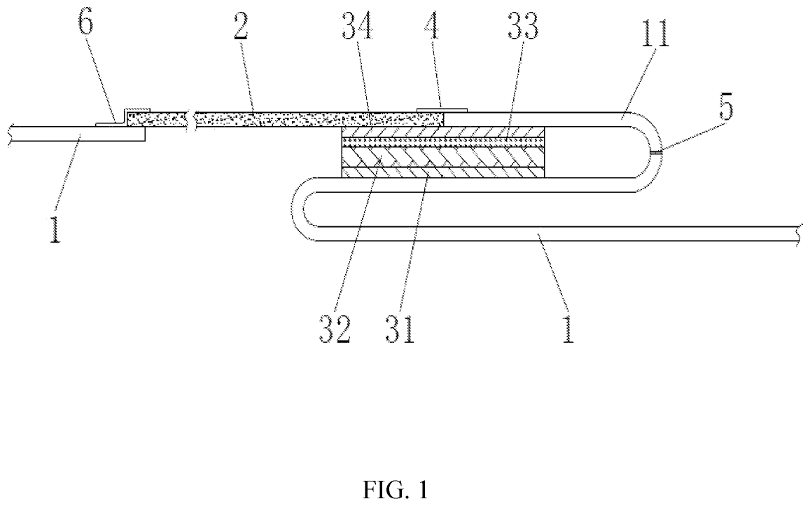

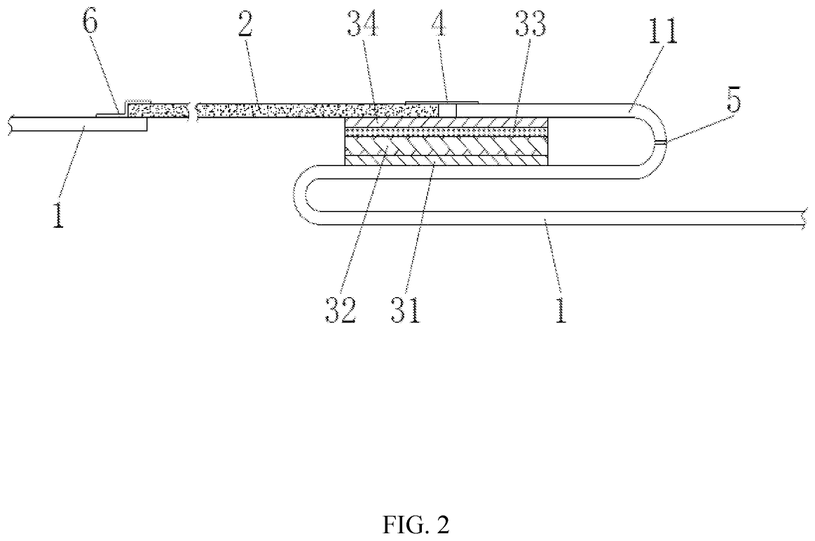

With reference to FIGS. 1 and 2, the packaging roll film may comprise non-adhesive film 1, extension portion 11, adhesive film 2, first high-adhesion layer 31, base layer 32, parting layer 33, second high-adhesion layer 34, first transparent adhesive tape 4, tearing line 5, and/or second transparent adhesive tape 6.

A first embodiment of a packaging roll film is shown in FIG. 1. A packaging roll film may comprise a plurality of packaging sections connected end to end, wherein each packaging section comprises a non-adhesive film 1 and an adhesive film 2 connected with the non-adhesive film 1. The non-adhesive film 1 and the adhesive film 2 may be bonded at the position where they are connected using a second transparent adhesive tape 6.

As shown in FIG. 1, the position where the adhesive film 2 and the non-adhesive film 1 of two adjacent packaging sections are connected may be provided with a bonding structure. The bonding structure may comprise a first high-adhesion layer 31 arranged on the non-adhesive film 1, a base layer 32 bonded to the surface of the first high-adhesion layer 31, a parting layer 33 arranged on the upper surface of the base layer 32, and a second high-adhesion layer 34 that is bonded to the parting layer 33 and is capable of being separated from the parting layer 33. The first high-adhesion layer 31 and the second high-adhesion layer 34 may be formed by a coating of an adhesion agent. The base layer 32 may comprise, but is not limited to a paper material. The parting layer 33 may be formed by coating a parting agent on the base layer 32.

As shown in FIG. 1, the end portion of the non-adhesive film 1 may be bent and bonded to the upper surface of the second high-adhesion layer 34; the end portion of the adhesive film 2 may be bonded to the upper surface of the second high-adhesion layer 34. The end portion of the adhesive film 2 that is bonded to the second high-adhesion layer 34, may be in contact with the end portion of the non-adhesive film 1 that also may be bonded to the second high-adhesion layer 34. The end portion surface of the adhesive film 2 opposite the second high-adhesion layer 34 may be bonded to the end portion surface of the non-adhesive film 1 opposite the second high-adhesion layer 34 using a first transparent adhesive tape 4.

A portion of the non-adhesive film 1 that is provided with a base layer 32 and a portion of the non-adhesive film 1 which is bonded to the second high-adhesion layer 34 and portions of the non-adhesive film therebetween may be characterized as forming an extension portion 11. The length of the extension portion 11 may 10-20 centimeters. In some embodiments, the length of the extension portion may be 12 centimeters, and a tearing line 5 may be arranged in the middle of extension portion 11. As shown, the end portion of the non-adhesive film 1 may be Z-shaped, which may cause the non-adhesive film 1 extend in a direction away from the adhesive film 2.

The first embodiment may provide the following benefits: When the film is provided on the drum to be used for wrapping, the adhesive film 2 and the non-adhesive film 1 of two adjacent packaging sections may be bonded using the first transparent adhesive tape 4, thus ensuring that the second high-adhesion layer 34 is covered. In this way, the technical problem caused by the exposed second high-adhesion layer 34 may effectively be solved. Accordingly, it may be unnecessary to make the adhesive film 2 and the non-adhesive film 1 completely cover the second high-adhesion layer 34 during the process, thereby making the preparation process more convenient.

When the roll film is unrolled for packaging an item, the rolling drum may stop rotating at the end of a cycle of the previous packaging section. The item being wrapped may continue to rotate due to the inertia such that a tension force is generated at the position where a previous packaging section and a latter packaging section are connected. As a result, the parting layer 33 may be parted from the second high-adhesion layer 34. This may allow the non-adhesive film 1 on the latter packaging section to be unrolled, and may enable the adhesive film 2 of the previous packaging section to continue wrapping the item. Moreover, due to the existence of the tension force, the second high-adhesion layer 34 may be smoothly bonded to and fixed upon the inner layer of the adhesive film 2. Subsequently, the tearing line 5 of the latter packaging section is torn apart such that the previous packaging section and the latter packaging section are separated.

Through the arrangement of the extension portion 11, the unrolled length of the non-adhesive film 1 of the latter packaging section may be increased, which may ensure that the adhesive film 2 of the previous packaging section continues to move an appropriate distance. It may also ensure that the second high-adhesion layer 34 may remain completely bonded to the inner layer of adhesive film 2 and is then torn apart at the tearing line 5.

A second embodiment of a packaging roll film is shown in FIG. 2. The embodiments are substantially similar. The difference between the first and second embodiments is that, as shown in FIG. 2, the end portion of the adhesive film 2 bonded to the second high-adhesion layer 34 is separated from the end portion of the non-adhesive film 1 bonded to the second high-adhesion layer 34. Accordingly, the first transparent adhesive tape 4 is arranged along and between the adhesive film 2 and the non-adhesive film 1 of two adjacent packaging sections. This may ensure that the second high-adhesion layer 34 is completely covered. Through adopting this arrangement, the end portion of the adhesive film 2 bonded to the second high-adhesion layer 34 and the end portion of the non-adhesive film 1 bonded to the second high-adhesion layer 34 may not need to be aligned with each other or even contact each other, thereby making the preparation process less difficult.

In a third embodiment, a method for preparing the packaging a roll film is provided. The method may comprise three main steps.

The first step may comprise preparing packaging sections. More specifically, it may include bonding and fixing a non-adhesive film 1 and an adhesive film 2 at a position where they are connected using a second transparent adhesive tape 6; and processing a tearing line 5 at one end of the non-adhesive film 1 away from the adhesive film 2.

The second step may comprise connecting two adjacent packaging sections. More specifically, it may include coating a portion of the first end of the non-adhesive film of a first packaging section of the adjacent packaging sections with an adhesion agent to form a first high-adhesion layer 31, the first end including the tearing line 5; bonding a base material on the first high-adhesion layer 31 to form a base layer 32; coating a parting agent on the base layer 32 to form a parting layer 33, coating an adhesion agent on the parting layer 33 to form a second high-adhesion layer 34, bending the end 5 of the non-adhesive film 1 and bonding the bent end to the second high-adhesion layer 34; and bonding one end of the adhesive film 2 of the latter packaging section to the second high-adhesion layer 34. Subsequently, the second step may include bonding the end portion surface of the adhesive film 2 opposite the second high-adhesion layer 34 and the end portion surface of the non-adhesive film 1 opposite the second high-adhesion layer 34 at the position where two adjacent packaging sections are connected using a first transparent adhesive tape 4. Finally, the second step may include bending a second end portion of non-adhesive film 1 towards the extension direction away from the other packaging section.

The third step may comprise preparing a packaging roll film. More specifically, it may include repeating step two multiple times, thus enabling a plurality of packaging sections to be connected end to end; and finally, rolling up the film to obtain a packaging roll film.

One beneficial effect of this method of preparation is as follows: at the position where a previous packaging section and a latter packaging section are connected, and where the adhesive film 2 and the non-adhesive film 1 are bonded to the second high-adhesion layer 34 from opposite directions, the first transparent adhesive tape 4 may be arranged over any space between the adhesive film 2 and the non-adhesive film 1 of two adjacent packaging sections, thus ensuring that the second high-adhesion layer 34 maybe completely covered. Accordingly, the disclosed roll film may operate properly regardless of whether the end portion of the adhesive film 2 bonded to the second high-adhesion layer 34 and the end portion of the non-adhesive film 1 bonded to the second high-adhesion layer 34 are in contact or separated. This may lower the difficulty of preparing embodiments of the packaging roll film.

Although the foregoing embodiments have been described in detail by way of illustration and example for purposes of clarity of understanding, it will be readily apparent to those of ordinary skill in the art in light of the description herein that certain changes and modifications may be made thereto without departing from the spirit or scope of the disclosure. It is also to be understood that the terminology used herein is for the purpose of describing particular aspects only, and is not intended to be limiting, since the scope of the present invention will be limited only by claims submitted in an application which claims priority to the instant application.

It is noted that, as used herein, the singular forms “a”, “an”, and “the” include plural referents unless the context clearly dictates otherwise. It is further noted that the claims in an application that claims priority to the instant disclosure may be drafted to exclude any optional element. As such, this statement is intended to serve as antecedent basis for use of such exclusive terminology as “solely,” “only,” and the like in connection with the recitation of claim elements, or use of a “negative” limitation. As will be apparent to those of ordinary skill in the art upon reading this disclosure, each of the individual aspects described and illustrated herein has discrete components and features which may be readily separated from or combined with the features of any of the other several aspects without departing from the scope or spirit of the disclosure. Any recited method can be carried out in the order of events recited or in any other order that is logically possible. Accordingly, the preceding merely provides illustrative examples. It will be appreciated that those of ordinary skill in the art will be able to devise various arrangements which, although not explicitly described or shown herein, embody the principles of the disclosure and are included within its spirit and scope.

Furthermore, all examples and conditional language recited herein are principally intended to aid the reader in understanding the principles of the invention and the concepts contributed by the inventors to furthering the art, and are to be construed without limitation to such specifically recited examples and conditions. Moreover, all statements herein reciting principles and aspects of the invention, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary configurations shown and described herein.

In this specification, various preferred embodiments have been described with reference to the accompanying drawings. It will be apparent, however, that various other modifications and changes may be made thereto and additional embodiments may be implemented without departing from the broader scope of this disclosure. The specification and drawings are accordingly to be regarded in an illustrative rather than restrictive sense.

We claim:

1. A packaging roll film, comprising:
a plurality of packaging sections connected end to end, wherein:
each packaging section includes a non-adhesive film and an adhesive film that is connected to the non-adhesive film;
a bonding structure disposed where the adhesive film and the non-adhesive film of second and first adjacent packaging sections, respectively, are connected;
the bonding structure comprises:
a first high-adhesion layer arranged on the non-adhesive film,
a base layer bonded to a surface of the first high-adhesion layer,
a parting layer arranged on an upper surface of the base layer, and
a second high-adhesion layer bonded to the parting layer, the second high-adhesion layer capable of being separated from the parting layer;
an end portion of the non-adhesive film is bonded to an upper surface of the second high-adhesion layer;
a first end portion of the adhesive film is bonded to the upper surface of the second high-adhesion layer,
a second end portion surface of the adhesive film away from the second high-adhesion layer is bonded to the end portion surface of the non-adhesive film using a first transparent adhesive tape;
a tearing line is disposed between a second portion of the non-adhesive film provided with the base layer and the end portion of the non-adhesive film which is bonded to the second high-adhesion layer; and
the non-adhesive film is bent in a Z-shape such that a third portion of the non-adhesive film extends in a direction away from the adhesive film.

2. The packaging roll film of claim 1, wherein further:
the first end portion of the adhesive film bonded to the second high-adhesion layer and the end portion of the non-adhesive film bonded to the second high-adhesion layer are in direct contact.

3. The packaging roll film of claim 1, wherein further:
the first end portion of the adhesive film bonded to the second high-adhesion layer and the end portion of the non-adhesive film bonded to the second high-adhesion layer are separated.

4. The packaging roll film of claim 1, wherein further:
the end portion of the non-adhesive film, the second portion of the non-adhesive film, and a portion of the non-adhesive film therebetween form an extension portion.

5. The packaging roll film of claim 4, wherein:
the length of the extension portion is 10-20 centimeters.

6. The packaging roll film of claim 4, wherein:
the tearing line is disposed in the middle of the extension portion.

7. The packaging roll film of claim 6, wherein:
the length of the extension portion is 12 centimeters.

8. The packaging roll film of claim 1, wherein further:
the non-adhesive film and the adhesive film in the same packaging section are bonded using a second transparent adhesive tape.

9. A method for preparing a packaging roll film, comprising:
preparing packaging sections; and
connecting adjacent packaging sections, wherein
the step of preparing packaging sections comprises
bonding a non-adhesive film and an adhesive film using a second transparent adhesive tape to form each packaging section, and
processing a tearing line on the non-adhesive film on a first end of the non-adhesive film away from the bonded adhesive film; and
the step of connecting two adjacent packaging sections comprises
coating a portion of the first end of the non-adhesive film of a first packaging section of the adjacent packaging sections with an adhesion agent to form a first high-adhesion layer,
bonding a base material on the first high-adhesion layer to form a base layer,
coating a parting agent on the base layer to form a parting layer,
coating an adhesion agent on the parting layer to form a second high-adhesion layer,
bending the first end of the non-adhesive film and bonding a bent portion of the first end to the second high-adhesion layer,
bonding an end of the adhesive film of a second packaging section of the adjacent packaging sections to the second high-adhesion layer,
bonding the adhesive film of the second packaging section to the non-adhesive film of the first packaging section using a first transparent adhesive tape, and
bending a second end of the non-adhesive film of the first packaging section away from the second packaging section.

10. The method of claim 9, further comprising:
repeating the step of connecting two adjacent packaging sections to form a packaging film of at least three of packaging sections connected end to end; and
rolling up the at least three packaging sections to form a roll.
